(19) United States
(12) Patent Application Publication
(10) Pub. No.: US 2011/0012385 A1
(43) Pub. Date: Jan. 20, 2011

(54) MODULAR TAILGATE PROTECTORS AND LOAD SUPPORT SYSTEMS

(76) Inventor: Raimundas A. Erstikaitis, Tewksbury, NJ (US)

Correspondence Address: Doherty IP Law Group LLC, 37 Belvidere Ave, Washington, NJ, 07882, US

(21) Appl. No.: 12/505,450

(22) Filed: Jul. 17, 2009

(51) Int. Cl. B62D 25/00

(52) U.S. Cl. 296/57.1

(57) ABSTRACT

A modular tailgate protector that is infinitely adjustable for accommodating vehicle storage beds having different widths includes a horizontal support bar having a first end, a second end, and a longitudinal axis, and a pair of vertical support columns adapted for sliding along the longitudinal axis of the horizontal support bar for adjusting the spacing between the vertical support columns. The modular tailgate protector includes locking elements coupled with the vertical support columns for selectively locking the vertical support columns at selected locations along the longitudinal axis of the horizontal support bar. The vertical support columns are insertable into stake post openings located at a rear end of a vehicle storage bed for spacing the horizontal support bar from a tailgate so that items loaded in the vehicle storage bed do not impact against the tailgate.

### BACKGROUND OF THE INVENTION

1. Field of the Invention

The present invention generally relates to storage beds for trucks, and more specifically relates to tailgate protectors and load support systems for trucks.

2. Description of the Related Art

Pickup trucks have rear storage beds that are used for hauling and delivering items. Frequently, the items loaded in the rear beds of trucks are too long (e.g. ladders, wood beams, drywall, etc.), which requires the items to be placed atop a closed tailgate. Road conditions often cause the items supported by the top of the tailgate to bounce about with substantial force, which may dent, bend and/or damage the tailgate, and/or damage the latches and hinges connecting the tailgate to the truck bed. FIG. 1 shows a conventional pickup truck having a bent and damaged tailgate. A bent or damaged tailgate will not only diminish the aesthetic appearance of a truck, but it may also make it extremely difficult or impossible to properly open and close the tailgate.

There have been a number of efforts directed to protecting the tailgates of trucks. For example, referring to FIG. 2A of the present application, U.S. Pat. No. 4,389,067 to Rubio teaches that a rear portion 10 of a pickup truck includes sidewalls 12 and 14 and a tailgate 16 hinged along its lower edge 18 and latched at 20. Disposed above and slightly forward of the tailgate 16 is a protective device 22. Referring to FIG. 2B, the protective device 22 includes an elongated support beam 24 and a pair of support legs 26 that are bolted or welded to the support beam 24. The length of the beam 24 is selected to be approximately the same length as the outer width of truck sidewalls 12 and 14 while the lengths of legs 26 are selected to be substantially equal to or slightly larger than the depth of the load carrying compartment of the pickup truck. The ends of the beam 24 rest upon the sidewalls 12 and 14 of the truck 10, however, the load carried by the beam 24 is primarily supported by the legs 26 rather than the sides of the truck.

Referring to FIGS. 2B and 2C, the Rubio device also includes a pair of L-shaped flanges 28 that are welded to the beam 24, and a stiffening web 32 that is welded to both the L-shaped flange 28 and the beam 24. The flange 28 has a horizontal leg 33 having a length that is slightly greater than the width of the top edge 36 of tailgate the 16 (shown in phantom) and a vertical leg 34 that extends outside the tailgate 16 and holds the unit in place by sandwiching the top of the tailgate between the support legs 26 and the vertical second leg 34.

U.S. Pat. No. 3,698,760 to Lane teaches a tailgate protector and load bar having a horizontal elongated bar that is secured to the top outside surface of the tailgate of a pickup truck. U.S. Pat. No. 6,247,742 to Boudreaux discloses a tailgate protecting device for protecting a tailgate from impact damage. The tailgate protecting device includes a plate having a top edge, a bottom edge, a front side and a back side. A panel is securely attached to and substantially covers the back side of the plate. A first pair of securing means removably attaches the top edge of the plate to a top edge of a tailgate. A second pair of securing means removably attaches the bottom edge of the plate to a bottom edge of the tailgate.

Although the Rubio, Lane, and Boudreaux references discussed above teach providing protector devices for tailgates, all of the references teach that the protector devices should be directly coupled with the tailgate. As a result, bouncing loads may still apply impact forces on tailgates and the hinges and latches coupled with the tailgates, which may cause damage to the tailgates.

U.S. Pat. No. 5,197,642 to Cortelli teaches a freight stacking support apparatus for supporting oversized freight above a tailgate of a pickup truck. The apparatus includes a support beam, a securing bracket with a locking mechanism, a triggering button for activating the locking mechanism, and a receiving bracket. The brackets are affixed to opposing top rear edges of the side walls of a pickup truck and the ends of the support beam are received in slots in the opposing brackets such that the support beam resides parallel to and above the tailgate. When the apparatus is in position, it allows the user to safely transport freight without damaging the tailgate. In addition, it permits user access to the contents of the pickup truck bed through the pivotable tailgate without lifting or removing the supported freight. Although Cortelli provides a device for supporting oversized freight above a tailgate, the device must be permanently secured to the truck bed. As a result, the device cannot be easily moved from one truck to another truck. In addition, the Cortelli device does not provide structure for easily tying down oversized loads to the support beam of the device.

U.S. Pat. Nos. 6,213,530 and 6,343,826 to Bohannon teach an auxiliary load supporting apparatus for a vehicle having left and right sidewalls. The load supporting apparatus includes a first base mounted to the left sidewall and extending upwardly therefrom, a second base mounted to the right sidewall and extending upwardly therefrom, a first framework mounted to the first base and extending rearwardly therefrom away from the left sidewall, and a second framework mounted to the second base and extending rearwardly therefrom away from the right sidewall. The load is supported by the truck bed, the top of the tailgate, and by the top cross bar extending between the first framework and the second framework.

In spite of the above advances, there remains a need for improved tailgate protectors that do not apply load to the tailgate, or the hinges and latches connecting the tailgate with the truck bed. There is also a need for improved tailgate protectors that may be easily coupled to a truck bed without requiring special tools or fasteners. There also remains a need for tailgate protectors that may be easily moved from one truck to another, and that may be used for a range of trucks having different bed widths. In addition, there remains a need for tailgate protectors that enable oversized items within the truck to be easily secured to a horizontal support bar overlying the tailgate so that the items do not move around during transit. There is also a need for tailgate protectors that do not extend beyond the rear of the truck so that the tailgate protector may remain connected to the truck when items are not being hauled.

### SUMMARY OF THE INVENTION

The present invention provides a tailgate protector that may be used on a wide range of trucks having various sizes. The tailgate protector is infinitely adjustable so that it may be used with trucks having different storage bed widths. The tailgate protector may be used with a wide variety of vehicles including trucks, pickup trucks and trailers. The tailgate protector of the present invention may also be easily switched from one vehicle to another without requiring special tools or a complicated transfer procedure.

In one embodiment, a modular tailgate protector includes a horizontal support bar having a first end, a second end, and a longitudinal axis extending between the first and second ends, and a pair of vertical support columns having horizontal support bar openings adapted to receive the horizontal support bar, whereby the vertical support columns are adapted for sliding along the longitudinal axis of the horizontal support bar. The modular tailgate protector preferably includes a locking element coupled with each of the vertical support columns for selectively locking the vertical support columns at a desired location along the longitudinal axis of the horizontal support bar. The spacing between the first and second vertical support columns is infinitely adjustable for accommodating vehicle storage beds having different widths.

In one embodiment, the vertical support columns preferably have lower ends adapted for insertion into stake post openings of a vehicle storage bed for spacing the horizontal support bar from a tailgate located at a rear end of the vehicle storage bed. Spacing the horizontal support bar from the tailgate will insure that items supported by the horizontal support bar will not contact and damage the tailgate and the hinges and latches associated with the tailgate. The horizontal support bar and the vertical support columns are preferably made of materials selected from the group consisting of steel, stainless steel, chrome, aluminum and alloys thereof.

The modular tailgate protector preferably includes a pair of grommets insertable into the stake post openings, each grommet including a top covering flange and a central opening extending through the top covering flange. The central opening of the grommet is desirably adapted to receive and support the lower end of one of the vertical support columns upon insertion of the vertical support column into one of the stake post openings. The grommets preferably comprise polymer materials such as rubber or high density rubber.

In one embodiment, the horizontal support bar openings are located adjacent upper ends of the vertical support columns. Each of the locking elements is preferably in communication with one of the horizontal support bar openings. In one embodiment, the locking elements are preferably moveable between a first position for allowing the vertical support columns to slide along the horizontal support bar and a second position for locking the vertical support columns in place on the horizontal support bar.

In one embodiment, each locking element includes a threaded opening extending through the vertical support column and being in communication with the horizontal support bar opening, and a threaded fastener adapted to be received in the threaded opening. The threaded fastener is preferably advanceable into the horizontal support bar opening for engaging the horizontal support bar. In one embodiment, the threaded fastener desirably includes a threaded eyebolt having an eye section and a threaded shaft.

In one embodiment, the horizontal support bar has an outer surface having a tubular-shaped surface. In one embodiment, a horizontal support bar has a first substantially flat shoulder provided adjacent a first end of the horizontal support bar and a second substantially flat shoulder provided adjacent a second end of the horizontal support bar. The substantially flat shoulders preferably extend only part of the way around the circumference of the horizontal support bar, and only part of the way along the length of the horizontal support bar. The substantially flat shoulders desirably provide seating surfaces for fastening elements such as threaded eyebolts. In one embodiment, a threaded eyebolt may be tightened onto a vertical support column so that the distal end of a threaded eyebolt may abut against a substantially flat shoulder accessible at an outer surface of a horizontal support bar for locking the vertical support column in place relative to the horizontal support bar.

In one embodiment, a modular tailgate protector is infinitely adjustable for accommodating vehicle storage beds having different widths. The modular tailgate protector preferably includes a horizontal support bar having a first end, a second end, and a longitudinal axis extending between the first and second ends, and a pair of vertical support columns adapted for sliding along the longitudinal axis of the horizontal support bar for adjusting the spacing between the vertical support columns. The modular tailgate protector also preferably includes locking elements coupled with the vertical support columns for selectively locking the vertical support columns at selected locations along the longitudinal axis of the horizontal support bar. The vertical support columns are preferably insertable into stake post openings located at a rear end of a vehicle storage bed for spacing the horizontal support bar from a tailgate. The locking elements are desirably moveable between a first position for allowing the vertical support columns to slide along the horizontal support bar and a second position for locking the vertical support columns in place on the horizontal support bar.

In one embodiment, a modular tailgate protector includes a horizontal support bar having a first end, a second end, and a longitudinal axis extending between the first and second ends, and a pair of vertical support columns adapted for sliding along the longitudinal axis of the horizontal support bar for infinitely adjusting the spacing between the vertical support columns. The vertical support columns are preferably insertable into stake post openings on a vehicle storage bed for spacing the horizontal support bar from a tailgate located at a rear end of the vehicle storage bed. The modular tailgate protector preferably includes locking elements coupled with the vertical support columns for selectively locking the vertical support columns at selected locations along the longitudinal axis of the horizontal support bar. The spacing between the vertical support columns is desirably infinitely adjustable for accommodating vehicle storage beds having different widths.

In one embodiment, the vertical support columns have lower ends that are sized and shaped to substantially conform to the stake post openings. In one embodiment, the stake post openings are square or rectangular in shape, and the lower ends of the vertical support columns conform to the shape of the stake post openings.

These and other preferred embodiments of the present invention will be described in more detail below.

### BRIEF DESCRIPTION OF THE DRAWING

FIG. 1 shows a rear view of a conventional pickup truck having a bent tailgate.

FIGS. 2A-2C show a prior art tailgate protector.

FIG. 3 shows a tailgate protection system including a horizontal support bar, a pair of vertical support columns, a pair of threaded eyebolts, and a pair of grommets for the vertical support columns, in accordance with one embodiment of the present invention.

FIG. 4A shows a front view of the horizontal support bar shown in FIG. 3.

FIG. 4B shows a cross-sectional end view of the horizontal support bar shown in FIG. 4A.

FIG. 5A shows a side view of one of the vertical support columns shown in FIG. 3.

FIG. 5B shows a cross-sectional view of the vertical support column shown in FIG. 5A.

FIG. 6 shows a threaded eyebolt for a tailgate protection system, in accordance with one embodiment of the present invention.

FIG. 7A shows a top plan view of one of the support grommets shown in FIG. 3.

FIG. 7B shows a side view of the support grommet shown in FIG. 7A.

FIG. 8 shows a right side of a bed of a pickup truck including a pair of stake post openings.

FIG. 9A shows the tailgate protection system of FIG. 3 coupled with a pair of rear stake post openings, in accordance with one embodiment of the present invention.

FIG. 9B shows the tailgate protection system of FIG. 9A with items supported by the horizontal support bar, in accordance with one embodiment of the present invention.

FIG. 9C shows a second end of the tailgate protection system shown in FIG. 9B.

FIG. 10A shows a front view of a horizontal support bar of a tailgate protector system, in accordance with one embodiment of the present invention.

FIG. 10B shows a cross-sectional view of the horizontal support bar shown in FIG. 10A.

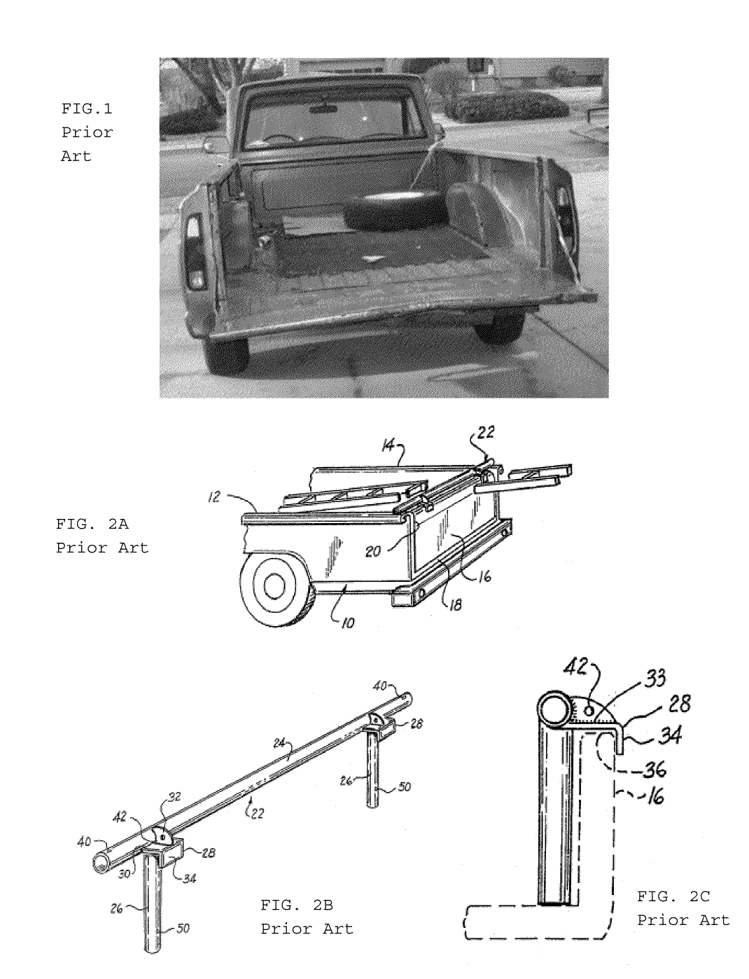

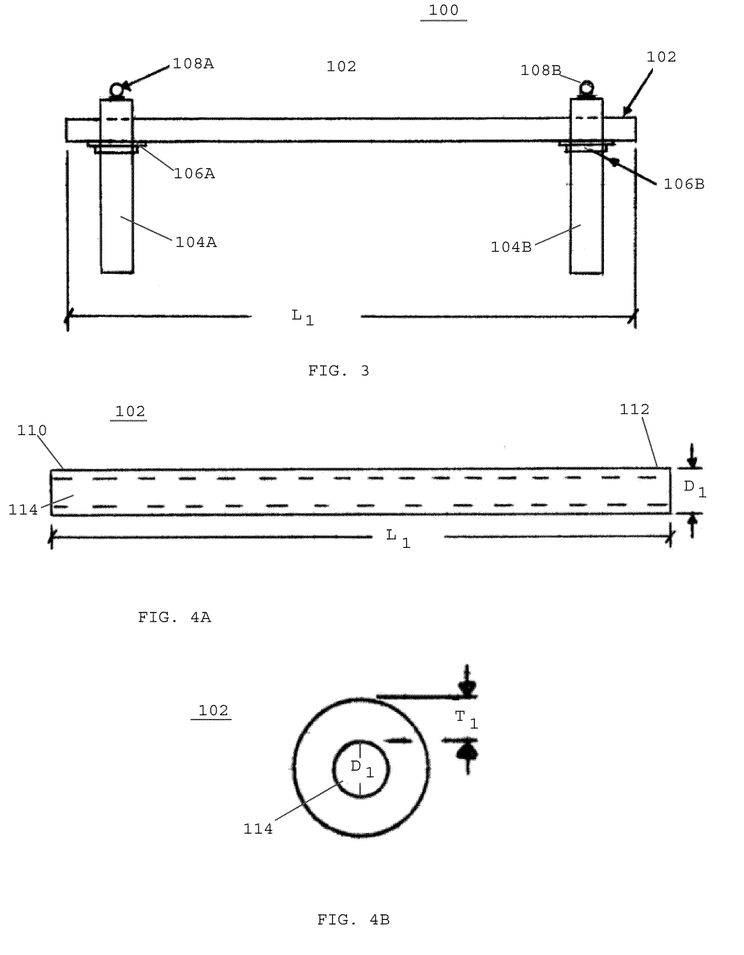

### DETAILED DESCRIPTION

Referring to FIG. 3, in one embodiment, a tailgate protection system 100 includes a horizontal support bar 102, a pair of vertical support columns 104A, 104B that receive the ends of the horizontal support bar 102, a pair of grommets 106A, 106B that are assembled with the vertical support columns 104A, 104B, and a pair of threaded eyebolts 108A, 108B that are threadable into the upper ends of the vertical support columns 104A, 104B.

Referring to FIG. 4A, in one embodiment, the horizontal support bar 102 has a first end 110 and a second end 112 opposite the first end. The horizontal support bar 102 preferably has an elongated central opening 114 that extends from the first end 110 to the second end 112. In one embodiment, the horizontal support bar 102 is made from a durable material such as metal. In a more preferred embodiment, the horizontal support bar 102 is made of stainless steel. In a highly preferred embodiment, the horizontal support bar 102 is made of aluminum or alloys thereof.

The horizontal support bar 102 preferably has a length L₁ that spans from the first end 110 to the second end 112. The length L₁ is preferably long enough to span the width of a truck bed. In one embodiment, the length L₁ is between about 5-7 feet, and more preferably about 6 feet. The horizontal support bar 102 has a diameter D₁ of about 1-3 inches and more preferably about 1.5 inches.

Referring to FIG. 4B, in one embodiment, the elongated central opening 114 of the horizontal support bar 102 has a diameter D₂ of about 0.50-1.00 inches and more preferably about 0.75 inches. In one embodiment, the horizontal support bar preferably has a thickness T₁ of about 0.25-0.50 inches and more preferably about 0.375 inches.

Referring to FIG. 5A, in one embodiment, a vertical support column 104 has an upper end 120 and a lower end 122. In one embodiment, the vertical support column 104 desirably has a length L₂ of about 6.00-12.00 inches and more preferably about 9.00 inches. In one embodiment, the upper end 120 defines a top surface 124 such as a curved, convex surface. The upper end 120 of the vertical support column 104 preferably includes a horizontal support bar opening 126 adapted to receive one of the ends of the horizontal support bar 102 (FIG. 3). The horizontal support bar opening 126 preferably has a diameter D₃ that closely matches the outer diameter D₁ of the horizontal support bar 102. In one embodiment, the horizontal support bar opening 126 has a diameter D₁ of about 1.00-3.00 inches and more preferably about 1.50 inches. In one embodiment, the ends of the horizontal support bar are adapted to slide into the horizontal support bar opening 126.

The vertical support column 104 desirably includes a threaded opening 128 that preferably extends along the longitudinal axis of the vertical support column from the top surface 124 thereof to the horizontal support bar opening 126. In one embodiment, the threaded opening 128 has a length L₃ of about 0.25-0.75 inches and more preferably about 0.50 inches. In one embodiment, the threaded opening has a diameter D₄ of about 0.25-0.50 inches and more preferably about 0.375 inches.

As is well known to those skilled in the art, the rear storage beds of pickup trucks typically have first and second sidewalls that define the left and right borders of the storage bed. The tops of the side walls typically have stake post openings formed therein. A conventional pickup bed may include a first sidewall having a front stake post opening and a rear stake post opening, and a second sidewall having a front stake post opening and a rear stake post opening. Referring to FIG. 5B, in one embodiment, the vertical support column 104 has an outer surface 130 that is sized and shaped to fit within one of the stake post openings in the storage bed of a truck. In one embodiment, the vertical support column 104 has a cross-sectional shape that is square or rectangular. In one embodiment, the vertical support column 104 has a width W₁ of about 1.75-2.50 inches and more preferably about 2.125 inches, and a thickness T₁ of about 1.00-2.00 inches and more preferably about 1.375 inches.

Referring to FIG. 6, in one embodiment, a fastening device 108, such as a threaded eyebolt, is adapted to be inserted into the threaded opening 128 at the top of the vertical support column 104. The threaded eyebolt 108 preferably has an eye 132 and a threaded shaft 134 projecting from the eye. The threaded shaft 134 preferably has a length L₄ that is at least equal to and preferably greater than the length L₃ of the threaded opening 128. The threaded opening 128 is preferably adapted to receive the threaded shaft 134 of the fastening device 108 for securing the horizontal support bar 102 (FIG. 3) relative to the vertical support column 104 (FIG. 5A).

Referring to FIG. 6, in one embodiment, the fastening device includes a washer 135 that is adapted for being positioned at a proximal end of the threaded shaft 134 for abutting against a shoulder adjacent the eye 132. The washer 135 is preferably made of a compliant material such as a polymer, nylon, or polypropylene. In one embodiment, when the fastening element 108 is tightened, the washer 135 is positioned between the shoulder adjacent the eye 132 and the top surface 124 of the vertical support column 104. In a preferred embodiment, the washer 135 is a nylon washer that is about a ⅜″ screw size. The washer 135 preferably has an outer diameter of about 0.750″ and a thickness of about 0.057″-0.067″. In one embodiment, a nylon washer is used because it is a durable material and because it effectively functions as a tightening cushion.

In one embodiment, the ends of the horizontal support bar are adapted to slide into the vertical support column opening 126. The spacing between the two vertical support columns is preferably determined by the spacing between the two rear stake post openings on the opposing sidewalls of the storage bed. The horizontal support bar is preferably centered between the two vertical support columns and the threaded eyebolts 108 are tightened for securing the horizontal support bar to the vertical support columns.

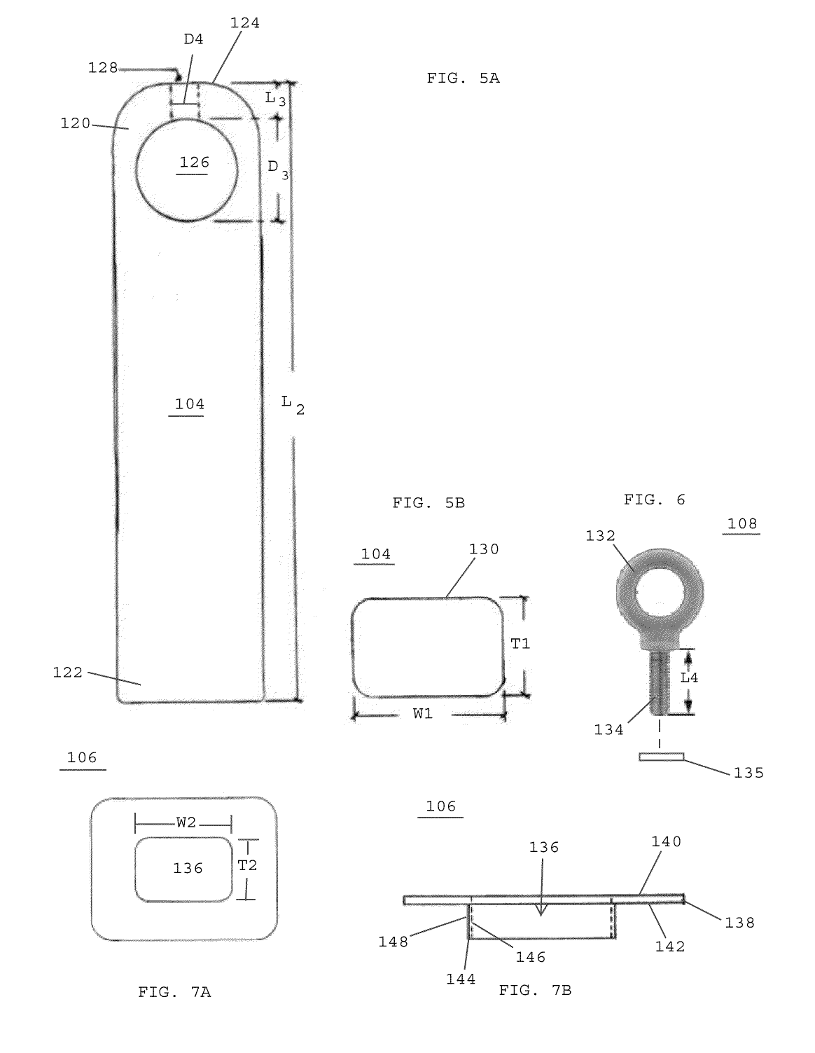

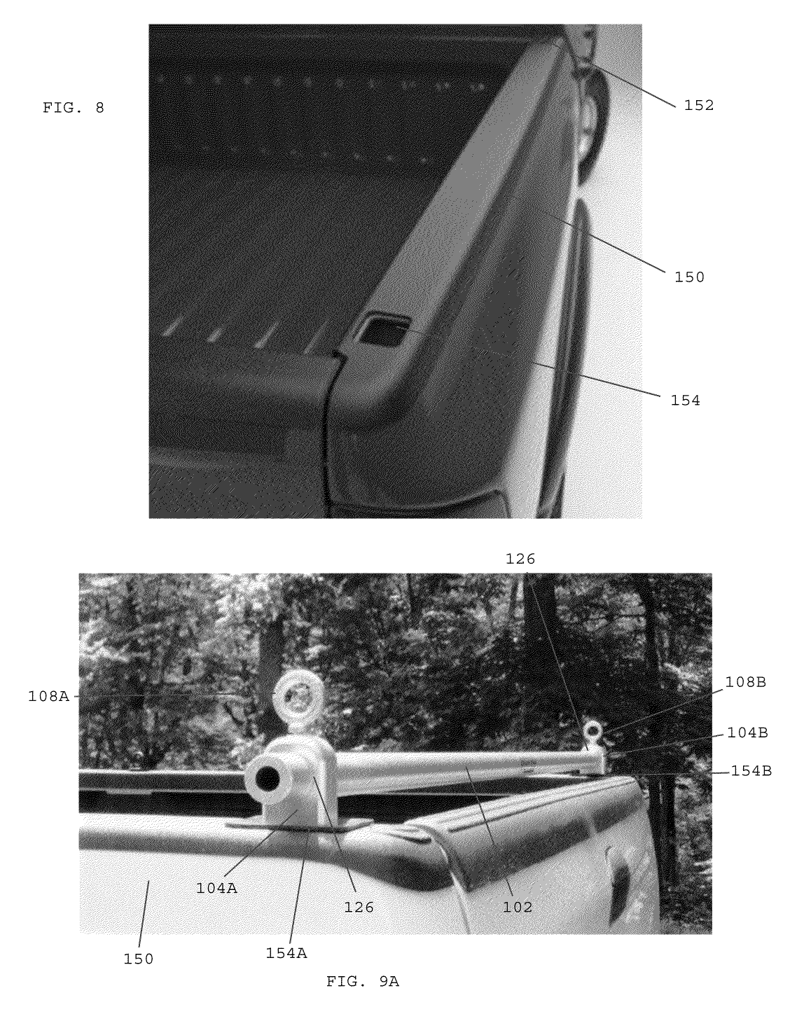

Referring to FIG. 7A, in one embodiment, the tailgate protection system includes a grommet 106 having a grommet opening 136 that is adapted to receive the shaft of the vertical support column 104 shown in FIGS. 5A and 5B. The grommet opening 136 preferably has a width W₂ and a thickness T₂ that substantially match the respective width W₁ and the thickness T₁ of the shaft of the vertical support column 104.

Referring to FIG. 7B, in one embodiment, the grommet 106 includes a grommet flange 138 having a top surface 140 and a bottom surface 142, whereby the grommet opening 136 extends between the top and bottom surfaces 140, 142 of the flange. The grommet 106 also preferably includes a plug 144 projecting from the bottom surface 142 of the flange 138. The plug 144 preferably has an inner surface 146 that closely matches the size and shape of the vertical support column 104 (FIG. 5A) and an outer surface 148 that conforms to the size and shape of a stake post opening in the bed of a truck.

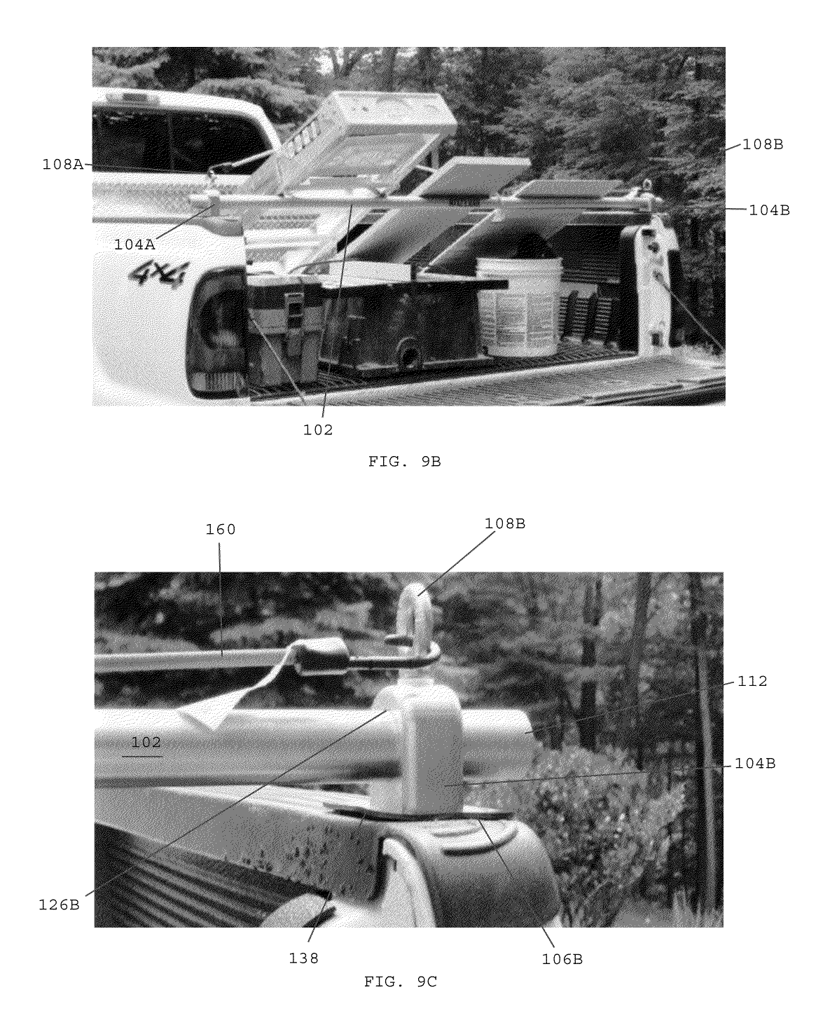

FIG. 8 shows a right side wall 150 of a truck bed. The right side wall 150 includes a forward stake post opening 152 and a rear stake post opening 154. In one embodiment, the stake post openings 152, 154 preferably define rectangular-shaped openings. As will be described in more detail below, the rear stake post opening 154 is adapted to receive one of the grommets 106 shown in FIGS. 7A and 7B, with one of the vertical support columns 104 (FIG. 5A) being insertable in the opening 136 of the grommet 106.

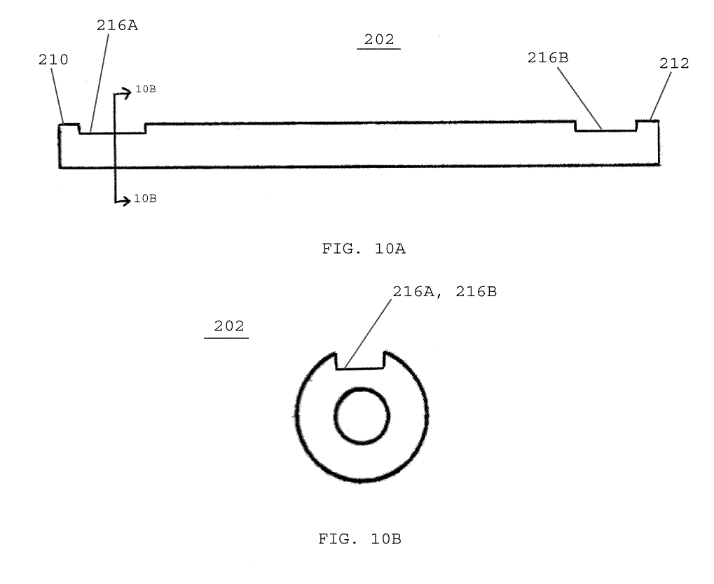

Referring to FIG. 9A, in one embodiment, a truck bed 150 includes a first rear stake post opening 154A formed in a left side wall of a truck bed and a second rear stake post opening 154B formed in a right side wall of the truck bed. The tail gate protector 100 shown in FIG. 3 is inserted into the stake post openings 154A, 154B by inserting the first vertical support column 104A into the first stake post opening 154A and the second vertical support column 154B into the second stake post opening 154B. The first and second grommets 106A, 106B surround the shafts of the vertical support columns 104A, 104B and cover the tops of the stake post openings. The ends of the horizontal support bar 102 are preferably received in the openings 126 of the vertical support columns 104A, 104B, and eyebolts 108A, 108B are preferably threaded into the threaded openings in the vertical support columns for locking the position of the horizontal support bar 102 relative to the vertical support columns 104A, 104B.

The horizontal support bar 102 preferably extends over the top of the tailgate when the tailgate is in the closed position, thereby preventing items stored in the truck bed 150 from contacting the top of the tailgate, which will prevent damage to the tailgate.

FIG. 9B shows the tailgate protector 100 inserted into the rear stake post openings of the truck bed for protecting the tailgate. As shown in FIG. 9B, the tailgate may be opened and closed with the tailgate protector 100 in place, and the tailgate protector 100 will not interfere with the operation of the tailgate when it is installed on the truck bed. As shown in FIG. 9B, long objects such as a ladder or wood may be positioned atop the horizontal support bar 102. The bar 102 prevents the long objects from contacting the tailgate so that the tailgate will not be damaged by the objects during transit. The threaded eyebolts 108A, 108B are preferably threaded into the threaded openings at the tops of the vertical support columns and the eyebolts are tightened for securing the position of the horizontal support bar 102 relative to the vertical support columns 104A, 104B. The ability of the horizontal support bar to slide within the vertical support column openings before the horizontal support bar is locked in place desirably enables the tailgate protector system to be used with truck beds having different widths. For a wider bed, the vertical support columns will be wider apart. For a narrower bed, the vertical support columns will be closer together. The eyebolts 108A, 108B preferably enable tie-down elements such as a rope or a bungee cord to be passed through the openings of the eyebolts for quickly and effectively tying down items stored in the truck bed and supported by the horizontal support bar.

FIG. 9C shows the right grommet 106B secured in the second rear stake post opening. The flange 138 of the grommet 106B covers the edges of the stake post opening, and the vertical support column is inserted into the central grommet opening 136 (FIG. 7A). The second end 112 of the horizontal support bar 102 is passed through the opening 126B adjacent the upper end 120 of the vertical support column. The threaded shaft of the eyebolt 108B may be threaded into the threaded opening of the vertical support column 104B for securing the horizontal support bar 102 in place relative to the vertical support column 104. A tie-down element such as a bungee cord 160 may be passed through the opening of the eyebolt 108 for tying down items over the tailgate protector 100.

Referring to FIGS. 10A and 10B, in one embodiment, a horizontal support bar 202 has a tubular shaped outer surface. In one embodiment, the horizontal support bar 202 has a first end 210 with a first substantially flat shoulder 216A provided adjacent the first end, and a second end 212 with a second substantially flat shoulder 216B provided adjacent the second end. The substantially flat shoulders 216A, 216B preferably extend only part of the way around the circumference of the horizontal support bar 202, and only part of the way along the length of the horizontal support bar. The shoulders 216A, 216B preferably do not extend all the way to the ends of the horizontal support bar but only a portion of the length of the horizontal support bar. The substantially flat shoulders 216A, 216B desirably provide seating surfaces for fastening elements such as threaded eyebolts. In one embodiment, a threaded eyebolt may be tightened onto a vertical support column so that the distal end of a threaded eyebolt may abut against one of the substantially flat shoulders 216A, 216B accessible at an outer surface of a horizontal support bar for locking the vertical support column in place relative to the horizontal support bar. Although the present invention is not limited by any particular theory of operation, it is believed that providing a substantially flat shoulder area on an outer surface of a horizontal support bar will enhance locking forces between a fastening element and the horizontal support bar.

While the foregoing is directed to embodiments of the present invention, other and further embodiments of the invention may be devised without departing from the basic scope thereof. As such, the scope of the present invention is to be limited only as set forth in the appended claims.

What is claimed is:

1. A modular tailgate protector comprising:
a horizontal support bar having a first end, a second end, and a longitudinal axis extending between the first and second ends;
a pair of vertical support columns having horizontal support bar openings adapted to receive said horizontal support bar, wherein said vertical support columns are adapted for sliding along the longitudinal axis of said horizontal support bar; and
a locking element coupled with each of said vertical support columns for selectively locking said vertical support columns at a desired location along the longitudinal axis of said horizontal support bar, wherein the spacing between said first and second vertical support columns is infinitely adjustable for accommodating vehicle storage beds having different widths.

2. The modular tailgate protector as claimed in claim 1, wherein said vertical support columns have lower ends adapted for insertion into stake post openings of a vehicle storage bed for spacing said horizontal support bar from a tailgate located at a rear end of said vehicle storage bed.

3. The modular tailgate protector as claimed in claim 2, further comprising a pair of grommets insertable into said stake post openings, each said grommet including a top covering flange and a central opening extending through said top covering flange, the central opening of said grommet being adapted to receive and support the lower end of one of said vertical support columns upon insertion of said vertical support column into one of said stake post openings.

4. The modular tailgate protector as claimed in claim 1, wherein said horizontal support bar openings are located adjacent upper ends of said vertical support columns.

5. The modular tailgate protector as claimed in claim 4, wherein each said locking element is in communication with one of said horizontal support bar openings.

6. The modular tailgate protector as claimed in claim 5, wherein said locking elements are moveable between a first position for allowing said vertical support columns to slide along said horizontal support bar and a second position for locking said vertical support columns in place on said horizontal support bar.

7. The modular tailgate protector as claimed in claim 5, wherein each said locking element comprises:
a threaded opening extending through said vertical support column and being in communication with said horizontal support bar opening; and
a threaded fastener adapted to be received in said threaded opening, wherein said threaded fastener is advanceable into said horizontal support bar opening for engaging said horizontal support bar.

8. The modular tailgate protector as claimed in claim 7, wherein said threaded fastener comprises a threaded eyebolt having an eye section and a threaded shaft.

9. The modular tailgate protector as claimed in claim 1, wherein said horizontal support bar has an outer surface including a first substantially flat shoulder adjacent the first end of said horizontal support bar and a second substantially flat shoulder adjacent the second end of said horizontal support bar.

10. The modular tailgate protector as claimed in claim 1, wherein said horizontal support bar and said vertical support columns comprises materials selected from the group consisting of steel, stainless steel, chrome, aluminum and alloys thereof.

11. A modular tailgate protector that is infinitely adjustable for accommodating vehicle storage beds having different widths comprising:
a horizontal support bar having a first end, a second end, and a longitudinal axis extending between the first and second ends;
a pair of vertical support columns adapted for sliding along the longitudinal axis of said horizontal support bar for adjusting the spacing between said vertical support columns; and
locking elements coupled with said vertical support columns for selectively locking said vertical support columns at selected locations along the longitudinal axis of said horizontal support bar, wherein said vertical support columns are insertable into stake post openings located at a rear end of a vehicle storage bed for spacing said horizontal support bar from a tailgate.

12. The modular tailgate protector as claimed in claim 11, wherein said locking elements are moveable between a first position for allowing said vertical support columns to slide along said horizontal support bar to a second position for locking said vertical support columns in place on said horizontal support bar.

13. The modular tailgate protector as claimed in claim 11, wherein each said vertical support column has an upper end including a horizontal support bar opening extending therethrough that is adapted to receive said horizontal support bar and a lower end adapted for insertion into one of said stake post openings on said vehicle storage bed.

14. The modular tailgate protector as claimed in claim 13, wherein each said locking element is in communication with one of said horizontal support bar openings.

15. The modular tailgate protector as claimed in claim 14, wherein each said locking element comprises:
a threaded opening extending through said vertical support column and being in communication with said horizontal support bar opening; and
a threaded fastener adapted to be received in said threaded opening, wherein said threaded fastener is advanceable into said horizontal support bar opening for engaging said horizontal support bar.

16. The modular tailgate protector as claimed in claim 15, wherein said threaded fastener comprises a threaded eyebolt having an eye section and a threaded shaft.

17. The modular tailgate protector as claimed in claim 11, further comprising a pair of grommets insertable into said stake post openings, each said grommet including a top covering flange and a central opening extending through said top covering flange, the central opening of said grommet being adapted to receive and support one of said vertical support columns upon insertion of said vertical support column into one of said stake post openings.

18. The modular tailgate protector as claimed in claim 17, wherein said grommets comprise rubber.

19. A modular tailgate protector comprising:
a horizontal support bar having a first end, a second end, and a longitudinal axis extending between the first and second ends;
a pair of vertical support columns adapted for sliding along the longitudinal axis of said horizontal support bar for infinitely adjusting the spacing between said vertical support columns, wherein said vertical support columns are insertable into stake post openings on a vehicle storage bed for spacing said horizontal support bar from a tailgate located at a rear end of said vehicle storage bed; and
locking elements coupled with said vertical support columns for selectively locking said vertical support columns at selected locations along the longitudinal axis of said horizontal support bar, wherein the spacing between said vertical support columns is infinitely adjustable for accommodating vehicle storage beds having different widths.

20. The modular tailgate protector as claimed in claim 19, wherein said vertical support columns have lower ends that are sized and shaped to substantially conform to said stake post openings.
